(19) United States
(12) Patent Application Publication
(10) Pub. No.: US 2022/0389329 A1
(43) Pub. Date: Dec. 8, 2022

(54) PROCESSES FOR PRODUCING HYDROCARBON MATERIAL FROM ORGANIC FEEDSTOCK

(71) Applicant: FORGE HYDROCARBONS CORPORATION, Oakville (CA)

(72) Inventors: Cornelius Teunis VANKNOTSENBURG, Oakville (CA); Carla Ann BRENNER, Oakville (CA); Michael Todd WELDON, Oakville (CA)

(21) Appl. No.: 17/774,837

(22) PCT Filed: Nov. 6, 2020
(86) PCT No.: PCT/CA2020/051508

§ 371 Date: May 5, 2022

Related U.S. Application Data
(60) Provisional application No. 62/931,319, filed on Nov. 6, 2019.
(60) Provisional application No. 62/931,300, filed on Nov. 6, 2019.
(60) Provisional application No. 62/931,291, filed on Nov. 6, 2019.
(60) Provisional application No. 62/931,281, filed on Nov. 6, 2019.

(51) Int. Cl. C10G 3/00

(52) U.S. Cl. CPC C10G 3/40; C10G 3/60; C10G 2300/1011; C10G 2300/4006; C10G 2300/4012; C10G 2300/4081

(57) ABSTRACT

There is provided a process for producing hydrocarbon material from a hydrocarbon material precursor which includes free fatty acid material, comprising: supplying a hydrocarbon material precursor-comprising feed material to a conversion zone, with effect that the hydrocarbon material precursor-comprising feed material is converted to a gaseous hydrocarbon material-comprising product; condensing a portion of the gaseous hydrocarbon material-comprising product such that a condensed hydrocarbon material-comprising product is obtained; and recycling the condensed hydrocarbon material-comprising product to the conversion zone as a reflux; wherein the condensing is effected in response to emplacement of the gaseous hydrocarbon material-comprising product in heat transfer communication with a heat sink disposed externally of the conversion zone.

### FIELD

The present disclosure relates to the conversion of fatty acid material to hydrocarbon material.

### BACKGROUND

There are increasing social and economic pressures to develop renewable energy sources as well as renewable and biodegradable industrial and consumer products and materials. There is a new focus on biorefining, which can be described as the processing of agricultural and forestry feedstocks capturing increased value by processing them into multiple products including biodiesel. Conversion of such feedstocks into multiple products, using existing technologies, however, can still be improved.

### SUMMARY

In one respect, there is provided a process for producing hydrocarbon material from a hydrocarbon material precursor which includes free fatty acid material, comprising:
supplying a hydrocarbon material precursor-comprising feed material to a conversion zone, with effect that the hydrocarbon material precursor-comprising feed material is converted to a gaseous hydrocarbon material-comprising product;
condensing a portion of the gaseous hydrocarbon material-comprising product such that a condensed hydrocarbon material-comprising product is obtained; and
recycling the condensed hydrocarbon material-comprising product to the conversion zone as a reflux;
wherein:
   the condensing is effected in response to emplacement of the gaseous hydrocarbon material-comprising product in heat transfer communication with a heat sink disposed externally of the conversion zone.

In another aspect, there is provided a process for producing hydrocarbon material from a hydrocarbon material precursor which includes free fatty acid material, comprising:
while: (i) a hydrocarbon material precursor-comprising feed material is being supplied to a conversion zone, (ii) the hydrocarbon material precursor-comprising feed material is being converted to a gaseous hydrocarbon material-comprising product within the conversion zone, and (iii) the gaseous hydrocarbon material-comprising product is being emplaced in heat transfer communication with a heat sink disposed externally of the conversion zone such that a portion of the gaseous hydrocarbon material-comprising product is condensed with effect that a condensed hydrocarbon material-comprising product is obtained externally of the conversion zone:
   recycling the condensed hydrocarbon material-comprising product to the conversion zone.

In another aspect, there is provided a process for producing hydrocarbon material from a hydrocarbon material precursor which includes free fatty acid material, comprising:
supplying a hydrocarbon material precursor-comprising feed material to a conversion zone, with effect that the hydrocarbon material precursor-comprising feed material flow is converted to a hydrocarbon material-comprising product; 1

recovering the hydrocarbon material-comprising product from the conversion zone; and
refluxing a portion of the recovered hydrocarbon material-comprising product to the conversion zone;
wherein:
   the fraction of the recovered gaseous hydrocarbon material-comprising product which is being refluxed to the conversion zone defines a reflux ratio: and
   the reflux ratio in based upon at least one sensed parameter, and the at least one sensed parameter includes at least one of: (i) chain length of hydrocarbon material within the gaseous hydrocarbon material-comprising product, and (ii) chain length of free fatty acid material within the gaseous hydrocarbon material-comprising product;
   such that the process further comprises at least one of: (i) sensing of chain length of hydrocarbon material within the gaseous hydrocarbon material-comprising product, and (ii) sensing of chain length of free fatty acid material within the gaseous hydrocarbon material-comprising product.

In another aspect, there is provided a process for producing hydrocarbon material from a hydrocarbon material precursor which includes free fatty acid material, comprising:
while: (i) a hydrocarbon material precursor-comprising feed material is being supplied to a conversion zone, (ii) the hydrocarbon material precursor-comprising feed material is being converted to a hydrocarbon material-comprising product within the conversion zone, (iii) the hydrocarbon material-comprising product is being recovered from the conversion zone; and (iv) the recovered hydrocarbon material-comprising product is being monitored for at least one of: (a) chain length of hydrocarbon material within the gaseous hydrocarbon material-comprising product, and (b) chain length of free fatty acid material within the gaseous hydrocarbon material-comprising product:
refluxing at least a portion of the recovered hydrocarbon material-comprising product to the conversion zone based on at least the monitoring.

In another aspect, there is provided a process for producing hydrocarbon material from a hydrocarbon material precursor which includes free fatty acid material, comprising:
within an internal space of a process vessel, converting the hydrocarbon material precursor to an intermediate material mixture, wherein the converting includes reactive transformation of at least a portion of the hydrocarbon material precursor via a reactive process within a reaction zone;
in response to at least buoyancy forces, separating the intermediate material mixture into at least a gaseous hydrocarbon material-comprising product and a liquid hydrocarbon material-comprising product;
discharging the separated liquid hydrocarbon material-comprising product from the process vessel such that an externally-disposed liquid hydrocarbon material-comprising product is obtained;
admixing at least a portion of the externally-disposed liquid hydrocarbon material-comprising product with a hydrocarbon material precursor-comprising feed such that a combined material is obtained;
supplying the combined feed material to the reaction zone; and
co-operatively emplacing a heating source relative to the at least a portion of the externally-disposed liquid hydrocarbon material-comprising product and the hydrocarbon material precursor-comprising feed, such that, prior to the supplying of the combined feed material to the reaction zone, heating of both of the at least a portion of the externally-disposed liquid hydrocarbon material-comprising product and the hydrocarbon material precursor-comprising feed, by the heating source, is effected.

In another aspect, there is provided a process for producing hydrocarbon material from a hydrocarbon material precursor which includes free fatty acid material, comprising:
while: (i) within an internal space of a process vessel, converting the hydrocarbon material precursor to an intermediate material mixture, wherein the converting includes reactive transformation of at least a portion of the hydrocarbon material precursor via a reactive process within a reaction zone; (ii) in response to at least buoyancy forces, separating the intermediate material mixture into at least a gaseous hydrocarbon material-comprising product and a liquid hydrocarbon material-comprising product; (iii) discharging the separated liquid hydrocarbon material-comprising product from the process vessel such that an externally-disposed liquid hydrocarbon material-comprising product is obtained; (iv) admixing at least a portion of the externally-disposed liquid hydrocarbon material-comprising product with a hydrocarbon material precursor-comprising feed such that a combined material is obtained; and (v) supplying the combined feed material to the reaction zone;
   co-operatively emplacing a heating source relative to the at least a portion of the externally-disposed liquid hydrocarbon material-comprising product and the hydrocarbon material precursor-comprising feed, such that, prior to the supplying of the combined feed material to the reaction zone, heating of both of the at least a portion of the externally-disposed liquid hydrocarbon material-comprising product and the hydrocarbon material precursor-comprising feed, by the heating source, is effected.

In another aspect, there is provided a process for producing hydrocarbon material from a hydrocarbon material precursor which includes free fatty acid material, comprising:
within an internal space of a process vessel, converting the hydrocarbon material precursor to an intermediate material mixture, wherein the converting includes reactive transformation of at least a portion of the hydrocarbon material precursor via a reactive process within a reaction zone;
in response to at least buoyancy forces, separating the intermediate material mixture into at least a gaseous hydrocarbon material-comprising product and a liquid hydrocarbon material-comprising product;
discharging the separated liquid hydrocarbon material-comprising product from the process vessel such that an externally-disposed liquid hydrocarbon material-comprising product is obtained;
heating at least a portion of the externally-disposed liquid hydrocarbon material-comprising product to obtain a heated externally-disposed liquid hydrocarbon material-comprising product; and
supplying at least a portion of the heated externally-disposed liquid hydrocarbon material-comprising product to the reaction zone.

In another aspect, there is provided a process for producing hydrocarbon material from a hydrocarbon material precursor which includes free fatty acid material, comprising:
while: (i) within an internal space of a process vessel, converting the hydrocarbon material precursor to an intermediate material mixture, wherein the converting includes reactive transformation of at least a portion of the hydrocarbon material precursor via a reactive process within a reaction zone; (ii) in response to at least buoyancy forces, separating the intermediate material mixture into at least a gaseous hydrocarbon material-comprising product and a liquid hydrocarbon material-comprising product; (iii) discharging the separated liquid hydrocarbon material-comprising product from the process vessel such that an externally-disposed liquid hydrocarbon material-comprising product is obtained; and (iv) recirculating at least a portion of the externally-disposed liquid hydrocarbon material-comprising product to the reaction zone;
   heating the recirculating externally-disposed liquid hydrocarbon material-comprising product.

In another aspect, there is provided a process for producing hydrocarbon material from a hydrocarbon material precursor which includes free fatty acid material, comprising:
within an internal space of a process vessel, converting the hydrocarbon material precursor to an intermediate material mixture, wherein the converting includes reactive transformation of at least a portion of the hydrocarbon material precursor via a reactive process within a reaction zone;
in response to at least buoyancy forces, separating the intermediate material mixture into at least a gaseous hydrocarbon material-comprising product and a liquid hydrocarbon material-comprising product;
discharging the separated liquid hydrocarbon material-comprising product from the process vessel such that an externally-disposed liquid hydrocarbon material-comprising product is obtained;
removing solid material from at least a portion of the externally-disposed liquid hydrocarbon material-comprising product to obtain a solids-depleted externally-disposed liquid hydrocarbon material-comprising product; and
supplying at least a portion of the solids-depleted externally-disposed liquid hydrocarbon material-comprising product to the reaction zone.

In another aspect, there is provide a process for producing hydrocarbon material from a hydrocarbon material precursor which includes free fatty acid material, comprising:
while: (i) within an internal space of a process vessel, converting the hydrocarbon material precursor to an intermediate material mixture, wherein the converting includes reactive transformation of at least a portion of the hydrocarbon material precursor via a reactive process within a reaction zone; (ii) in response to at least buoyancy forces, separating the intermediate material mixture into at least a gaseous hydrocarbon material-comprising product and a liquid hydrocarbon material-comprising product; (iii) discharging the separated liquid hydrocarbon material-comprising product from the process vessel such that an externally-disposed liquid hydrocarbon material-comprising product is obtained; and (iv) recirculating at least a portion of the externally-disposed liquid hydrocarbon material-comprising product to the reaction zone; 1

removing solid material from at least the recirculating externally-disposed liquid hydrocarbon material-comprising product, such that the externally-disposed liquid hydrocarbon material-comprising product, being recirculated to the reaction zone, is depleted in solids relative to the externally-disposed liquid hydrocarbon material-comprising product being discharged from the process vessel.

In another aspect, there is provided a process for producing hydrocarbon material from a hydrocarbon material precursor which includes free fatty acid material, comprising:
within an internal space of a process vessel, converting the hydrocarbon material precursor to an intermediate material mixture, wherein the converting includes reactive transformation of at least a portion of the hydrocarbon material precursor via a reactive process within a reaction zone;
in response to at least buoyancy forces, separating the intermediate material mixture into at least a gaseous hydrocarbon material-comprising product and a liquid hydrocarbon material-comprising product;
discharging the separated liquid hydrocarbon material-comprising product from the process vessel such that an externally-disposed liquid hydrocarbon material-comprising product is obtained;
based on volatility differences, fractionating at least a portion of the externally-disposed liquid hydrocarbon material-comprising product into a recovered gaseous material portion and a rejected residual slurry material portion; and
supplying the recovered gaseous material portion to the reaction zone.

In another aspect, there is provided a process for producing hydrocarbon material from a hydrocarbon material precursor which includes free fatty acid material, comprising:
while: (i) within an internal space of a process vessel, converting the hydrocarbon material precursor to an intermediate material mixture, wherein the converting includes reactive transformation of at least a portion of the hydrocarbon material precursor via a reactive process within a reaction zone; (ii) in response to at least buoyancy forces, separating the intermediate material mixture into at least a gaseous hydrocarbon material-comprising product and a liquid hydrocarbon material-comprising product; and (iii) discharging the separated liquid hydrocarbon material-comprising product from the process vessel such that an externally-disposed liquid hydrocarbon material-comprising product is obtained;
   based on volatility differences, fractionating at least a portion of the externally-disposed liquid hydrocarbon material-comprising product into a recovered gaseous material portion and a rejected residual slurry material portion; and
   supplying the recovered gaseous material portion to the reaction zone.

Other aspects will be apparent from the description and drawings provided herein.

### BRIEF DESCRIPTION OF DRAWINGST

The embodiments will now be described with reference to the following accompanying drawings, in which:

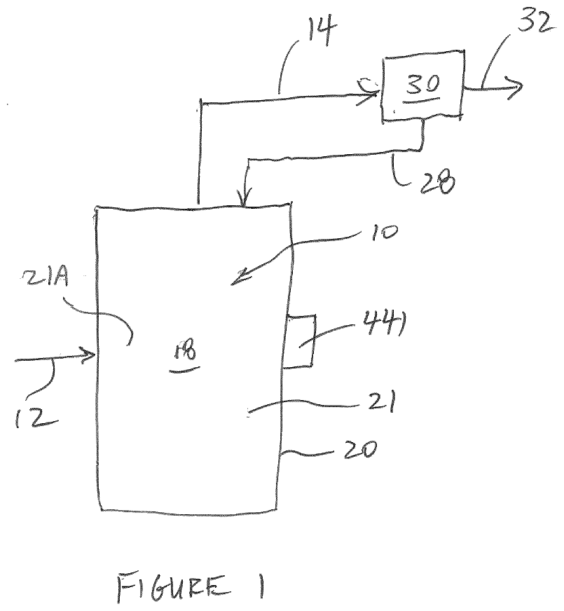

FIG. 1 is a process flow diagram of a first embodiment of a system within which a process of the present disclosure is employable;

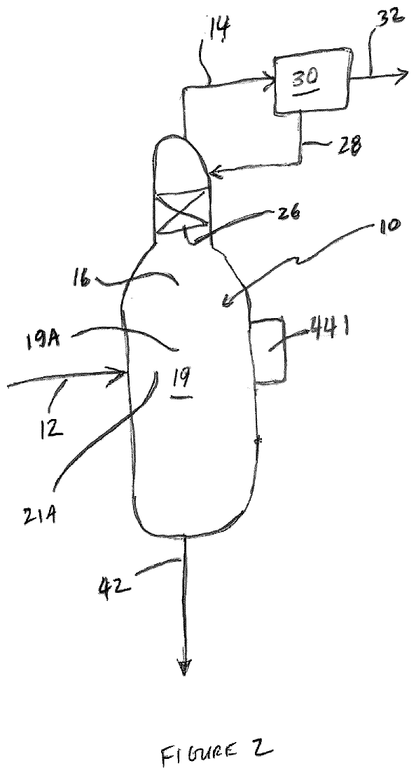

FIG. 2 is a process flow diagram of a second embodiment of a system within which a process of the present disclosure is employable;

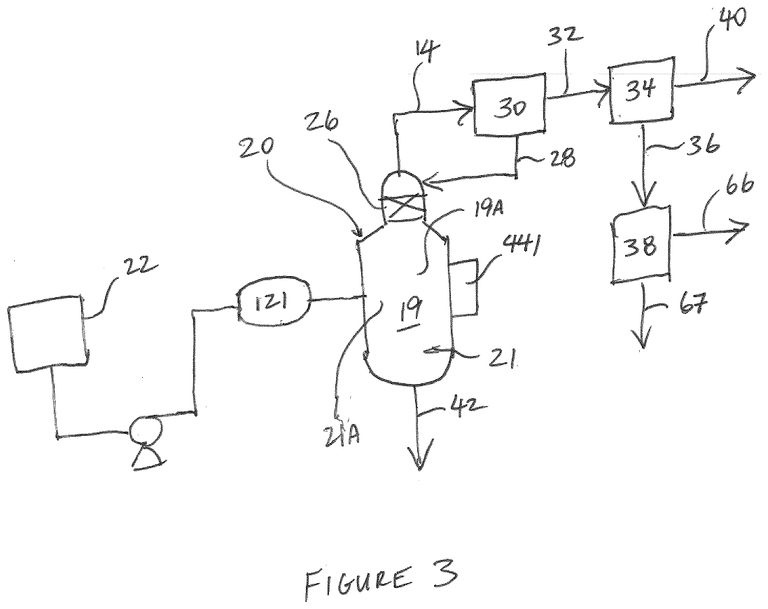

FIG. 3 is a process flow diagram of a third embodiment of a system within which a process of the present disclosure is employable;

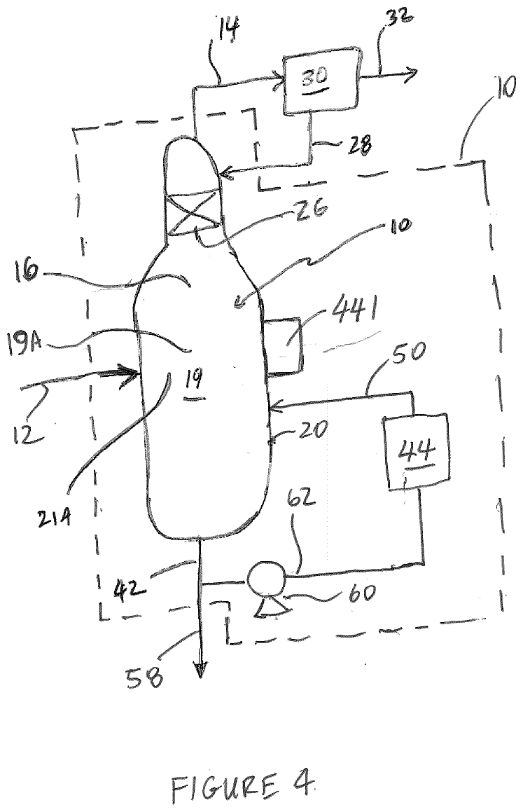

FIG. 4 is a process flow diagram of a fifth embodiment of a system within which a process of the present disclosure is employable;

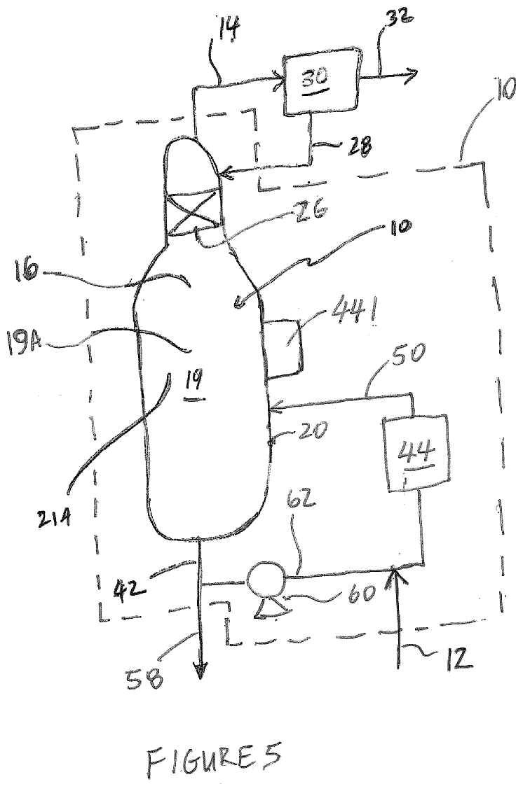

FIG. 5 is a process flow diagram of a fourth embodiment of a system within which a process of the present disclosure is employable;

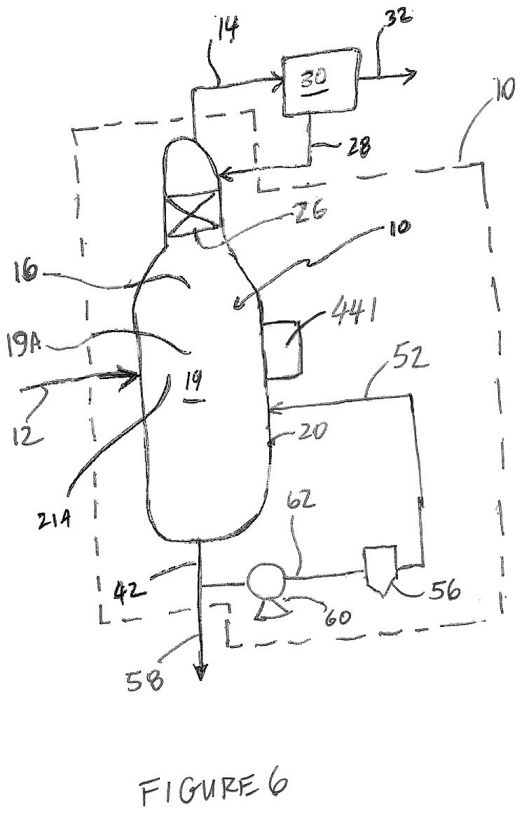

FIG. 6 is a process flow diagram of a sixth embodiment of a system within which a process of the present disclosure is employable;

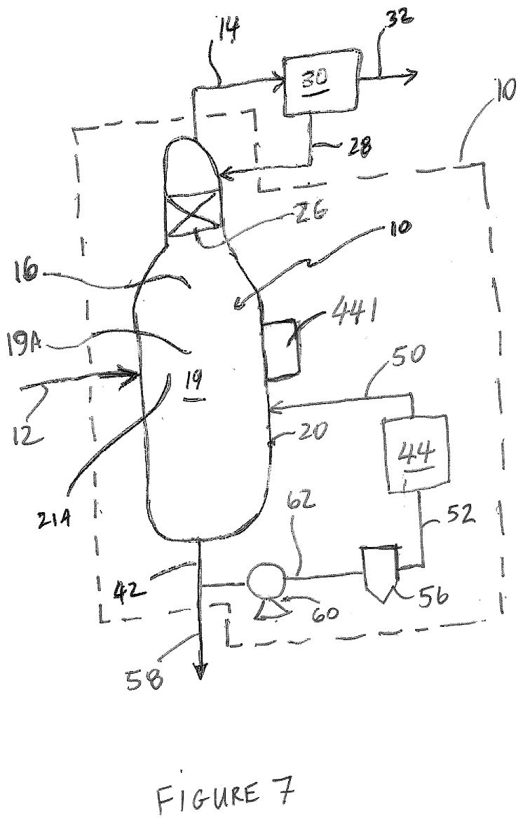

FIG. 7 is a process flow diagram of a seventh embodiment of a system within which a process of the present disclosure is employable; and

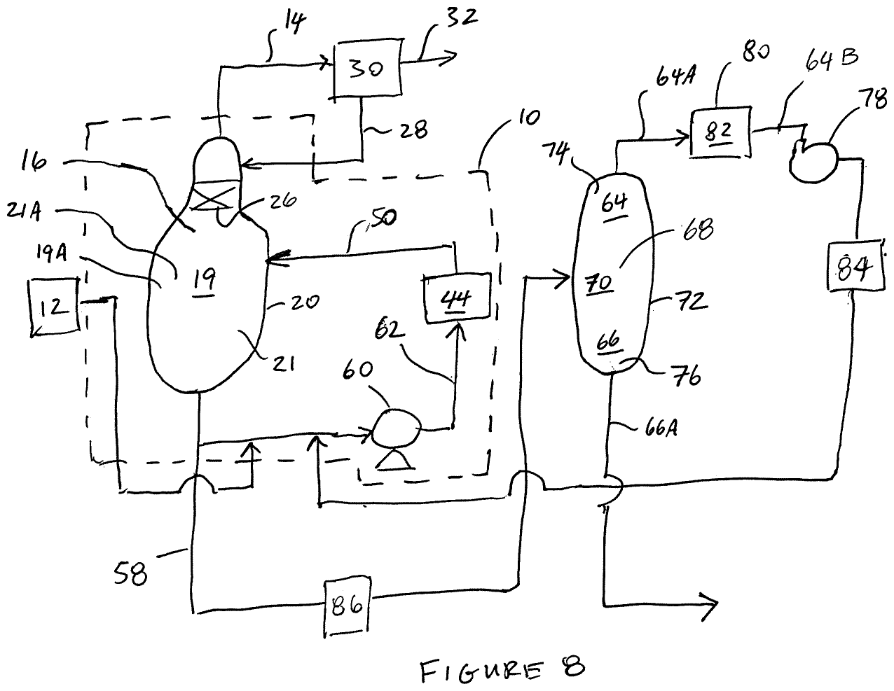

FIG. 8 is a process flow diagram of a seventh embodiment of a system within which a process of the present disclosure is employable.

### DETAILED DESCRIPTION

Referring to FIGS. 1 to 7, there is provided a process for producing hydrocarbon material from a hydrocarbon material (hereinafter “HM”) precursor. The HM precursor, from which the hydrocarbon material is produced, is disposed in a liquid state. The HM precursor includes fatty acid (hereinafter, “FA”) material.

FA material consists of at least one FA species. Each one of the at least one FA species, independently, is defined by a free fatty acid or its corresponding salt. In this respect, in some embodiments, for example, the FA material consists of free fatty acid material, and the free fatty acid material consists of one or more free fatty acid compounds.

The fatty acid can be a saturated fatty acid or an unsaturated fatty acid. Suitable fatty acids include butyric acid, lauric acid, myristic acid, palmitic acid, stearic acid, arachidic acid, alpha-linolenic acid, docosahexaenoic acid, eicosapentaenoic acid, linoleic acid, arachidonic acid, oleic acid, erucic acid, or any naturally derived fatty acid from a plant or animal source.

The FA material of the HM precursor defines a FA material-defined precursor component. In some embodiments, for example, the HM precursor includes at least 80 weight percent (such as, for example, at least 85 weight percent, such as, for example, at least 90 weight percent) of the FA material-defined precursor component based on the total weight of the HM precursor.

In some embodiments, for example, at least a fraction of the FA material-defined precursor component is derived from FA precursor material. Suitable FA precursor material include vegetable oils, plant oils, animal fats, fungal oils, tall oils, animal fats, biosolids, cooking oil, spent cooking oil, waste greases, or soapstock, or any combination thereof. Suitable vegetable oils include corn oil, cottonseed oil, canola oil, rapeseed oil, olive oil, palm oil, peanut oil, ground nut oil, safflower oil, sesame oil, soybean oil, sunflower oil, algal oil, almond oil, apricot oil, argan oil, avocado oil, ben oil, cashew oil, castor oil, grape seed oil, hazelnut oil, hemp seed oil, linseed oil, mustard oil neem oil, palm kernel oil, pumpkin seed oil, tall oil, rice bran oil, or walnut oil, or any combination thereof. Suitable animal fats include blubber, cod liver oil, ghee, lard, tallow, derivatives thereof (e.g., yellow grease, used cooking oil, etc.), or any combination thereof.

The FA precursor material includes at least one FA precursor compound. Exemplary FA precursor compounds include lipids, phospholipids, triglycerides, diglycerides, and monoglycerides.

In some embodiments, for example, the deriving of the FA material-defined precursor component from the FA precursor material is effected in response to conversion of at least one FA precursor compound, wherein the conversion is to a product material including at least one FA species. In this respect, in some embodiments, for example, the process includes, prior to the producing of the hydrocarbon material from the HM precursor, converting at least one FA precursor compound, of the FA precursor material, to a product material including at least one FA species, such that the FA material-defined precursor component, of the HM precursor, includes at least one FA species that is obtained from the converting of the at least one FA precursor compound. In some embodiments, for example, the conversion includes a reactive process, such as, for example, hydrolysis.

In some embodiments, for example, prior to the converting, the FA precursor material is subjected to pretreatment to remove moisture, metals, gums, proteins, and colour which may cause emulsification during hydrolysis. In some embodiments, for example, the pretreatment includes an acid treatment followed by an addition of an absorbent (bleaching clay or activated carbon). The absorbent is removed by filtration. Residual moisture in the FA precursor material is removed under vacuum.

In some embodiments, for example, the process includes, within a conversion zone 10, converting the HM precursor-comprising feed material 12 to at least a gaseous hydrocarbon material-comprising product 14. The gaseous hydrocarbon material-comprising product 14 includes gaseous hydrocarbon material (hereinafter, “GHM”). The GHM consists of one or more hydrocarbon compounds. In some embodiments, for example, the GHM includes gaseous target hydrocarbon material. Each one of the at least one hydrocarbon of the gaseous target hydrocarbon material, independently, includes a total number of carbon atoms of at least one (1) and no more than 24. In some embodiments, for example, the gaseous hydrocarbon material includes at least 50 weight percent (such as, for example, at least 60 weight percent, such as, for example, at least 70 weight percent, such as, for example, at least 80 weight percent) of gaseous target hydrocarbon material, based on the total weight of the gaseous hydrocarbon material.

In some embodiments, for example, the conversion of the HM precursor-comprising feed material 12 includes reactively transforming at least a portion of the HM precursor-comprising feed material 12 via a reactive process. In some embodiments, for example, at least a portion of the FA material-defined precursor component of the HM precursor-comprising feed material 12 is reactively transformed to the GHM. In some of these embodiments, for example, during the conversion, at least a portion of the FA material-defined precursor component of the HM precursor-comprising feed material 12 remains unreacted, or is reactively transformed to another material (such that the FA material-defined precursor component is only partially reactively transformed to the GHM). In this respect, in addition to the GHM, the GHM-comprising product 14 includes gaseous FA material, and the gaseous FA material includes unconverted and/or partially converted FA material-defined precursor component. The gaseous FA material of the GHM-comprising product 14 is derived from the FA material-defined precursor component. In this respect, in some embodiments, for example, the gaseous FA material includes one or more FA species, of the FA material-defined precursor component, that are vapourized during the converting of the HM precursor, and/or includes one or more gaseous FA species that are obtained from partial reactive transformation of one or more FA species of the FA material-defined precursor component. The gaseous FA material typically includes relatively lower molecular weight compounds characterized by relatively lower boiling points, such as, for example, short chain fatty acids.

Referring to FIGS. 1 to 3, in some embodiments, for example, for effecting the conversion within the conversion zone 10, the HM precursor-comprising feed material 12 is supplied to the conversion zone 10. In some embodiments, for example, the HM precursor-comprising feed material 12 is supplied from a feedstock tank 22 to a feed material-receiving zone 21A within an internal space 21 of a process vessel 20, for conversion within the conversion zone 10 disposed within the process vessel 20.

In some embodiments, for example, the converting includes, within the conversion zone 10, heating the HM precursor-comprising feed material 12. In some of these embodiments, for example, the heating includes, prior to supplying the feed material 12 to the process vessel, heating of the HM precursor-comprising feed within a pre-heater 121. In some embodiments, for example, the heating includes additionally, or alternatively, heating the feed material 12 within the conversion zone 10. In this respect, and referring to FIG. 5, in some embodiments, for example, the internal space 21 is disposed in heat transfer communication with a heat exchanger 441 such that heat is conducted from a heat exchanger to the internal space 21 for heating the internal space 21 for establishing the desired temperature conditions within the conversion zone 10. In some embodiments, the conduction is via the wall, of the process vessel 21, which defines the internal space 21. In those embodiments where the heating includes heating within a pre-heater 12, in some of these embodiments, for example, the conversion zone 10 is defined within both of the pre-heater 12 and the process vessel 20.

The reactive transformation of at least a portion of the HM precursor-comprising feed material 12 is effected by a reactive process within a reaction zone 18 of the conversion zone 10. An exemplary reactive process is pyrolysis (high temperature decomposition). Exemplary reactive processes occurring during pyrolysis include decarbonylation, decarboxylation, and thermal cracking, and condensation, or any combination thereof. During pyrolysis, oxygen groups are removed via decarboxylation and decarbonylation and the long chain hydrocarbons are cracked into the smaller chain molecules that comprise naphtha and diesel. The products of the pyrolysis include the GEM-comprising product 14 and a liquid hydrocarbon material-comprising product 42. In some embodiments, for example, the GEM-comprising product 14 includes the GHM, the FA material, carbon monoxide carbon dioxide, and diatomic hydrogen. In some embodiments, for example, the liquid hydrocarbon material-comprising product 42 includes liquid hydrocarbon compounds, such as, for example, liquid hydrocarbon compounds containing a total number of six (6) to 16 carbon atoms, free fatty acid compounds containing a total number of four (4) to 18 carbon atoms, water, and a solid carbon by-product made up of high molecular weight species such as large, polycyclic aromatics. In some embodiments, for example, the reactive process is effected in the absence of a catalyst. In some embodiments, for example, the reactive process is effected in the absence of adscititious diatomic hydrogen. In some embodiments, for example, the reactive process is effected in the absence of adscititious diatomic oxygen. In some embodiments, for example, the reactive process is effected in the absence of a catalyst and in the absence of adscititious diatomic hydrogen. In some embodiments, for example, the reactive process is effected in the absence of a catalyst, and in the absence of adscititious diatomic hydrogen, and in the absence of adscititious diatomic oxygen. In some embodiments, for example, the conversion zone and the supplying of the hydrocarbon material precursor-comprising feed material to the conversion zone 10 co-operate such that the space time, defined by the time required by the supplied hydrocarbon material precursor-comprising feed material to occupy the entirety of the conversion zone 10, is at least 10 minutes, such as, for example, at least 15 minutes. In some embodiments, for example, the conversion zone and the supplying of the hydrocarbon material precursor-comprising feed material to the conversion zone 10 co-operate such that the space time, defined by the time required by the supplied hydrocarbon material precursor-comprising feed material to occupy the entirety of the conversion zone 10, is from ten (10) minutes to 120 minutes, such as, for example, from ten (10) minutes to 90 minutes. In some embodiments, for example, the temperature within the reaction zone 18 is from 350 degrees Celsius to 500 degrees Celsius, such as, for example, from 360 degrees Celsius to 450 degrees Celsius. In some embodiments, for example, the pressure within the reaction zone 18 is from 100 psig to 250 psig.

In some embodiments, for example, the process is a continuous process and, in this respect, the process includes, while: (i) the HM precursor-comprising feed material 12 is being supplied to the conversion zone 10, and (ii) the HM precursor-comprising feed material 12 is being converted to the GEM-comprising product 14 within the conversion zone:
recovering the GEM-comprising product 14 from the conversion zone 10.

After the GEM-comprising product 14 is recovered, a portion of the recovered GHM-comprising product 14 is condensed such that a condensed HM-comprising product 28 is obtained, and the condensed HM-comprising product 28 (in the liquid state) is recycled to the conversion zone 10 for at least effecting further conversion of the GEM-comprising product 28 (such as, for example, via a reactive process within the reaction zone 19A of the conversion zone 19). In this respect, the HM-comprising product 28 functions as a reflux 28. In some embodiments, for example, the reflux 28 returns longer chain fatty acid material for further conversion within the conversion zone 10, and also returns longer chain hydrocarbon material for further conversion within the conversion zone 10. In some embodiments, for example, the HM-comprising product 28 which is returned to the conversion zone 10 defines a reflux ratio. An increased reflux ratio promotes obtaining a greater portion of shorter chain hydrocarbon material, and a reduced portion of longer chain FA material, within the recovered GEM-comprising product 14. In some embodiments, for example, the reflux ratio in based upon at least one parameter, and the at least one parameter includes at least one of: (i) chain length of hydrocarbon material within the hydrocarbon material-comprising product (14 or 28), and (ii) chain length of FA material (such as, for example, free fatty acid material) within the hydrocarbon material-comprising product (14 or 28).

In some embodiments, for example, the process further comprises sensing of chain length of hydrocarbon material within the HM-comprising product (14 or 28), and, in some of these embodiments, for example, the process further comprises modulating the reflux ratio based upon at least the sensing of the chain length of hydrocarbon material within the hydrocarbon material-comprising product (14 or 28). In some embodiments, for example, the process further comprises sensing of chain length of FA material (such as, for example, free fatty acid material) within the hydrocarbon material-comprising product (14 or 28), and, in some of these embodiments, for example, the process further comprises modulating the reflux ratio based upon at least the sensing of the chain length of FA material within the hydrocarbon material-comprising product (14 or 28). In some embodiments, for example, the process further comprises (i) sensing the hydrocarbon material-comprising product (14 or 28) for the chain length of hydrocarbon material within the hydrocarbon material-comprising product (14 or 28), and (ii) sensing the hydrocarbon material-comprising product (14 or 28) for the chain length of free fatty acid material within the hydrocarbon material-comprising product (14 or 28), and, in some of these embodiments, for example, the process further comprises modulating the reflux ratio based upon at least: (i) sensing of chain length of hydrocarbon material within the hydrocarbon material-comprising product (14 or 28); (ii) sensing of chain length of free fatty acid material within the hydrocarbon material-comprising product (14 or 28); or (iii) sensing of chain length of hydrocarbon material within the hydrocarbon material-comprising product (28) and sensing of chain length of free fatty acid material within the hydrocarbon material-comprising product (28).

In some embodiments, for example, the condensing of the portion of the GEM-comprising product 14 is effected via cooling of the GEM-comprising product 14 that is effected in response to emplacement of the GEM-comprising product 14 in heat transfer communication with a heat sink. In some embodiments, for example, the heat sink is a a cooling fluid, and the heat transfer communication is an indirect heat transfer communication. In some embodiments, for example, the indirect heat transfer communication is effected via a heat exchanger 30.

In some of these embodiments, for example, the process is a continuous process and, in this respect, the process includes, while: (i) the HM precursor-comprising feed material 12 is being supplied to the conversion zone 10, with effect that the HM precursor-comprising feed material 12 is converted to at least a GEM-comprising product 14, and (ii) the GEM-comprising product 14 is being recovered from the conversion zone 10:
condensing a portion of the GEM-comprising product 14 such that a condensed HM-comprising product 28 is obtained and recycled to the conversion zone 10.

Referring to FIGS. 2 and 3, in some embodiments, for example, the converting includes an intermediate conversion and a fractionation. The intermediate conversion is effected within the intermediate conversion zone 19 and the fractionation is effected within the fractionation zone 26. In this respect, the conversion zone 10 includes the intermediate conversion zone 19 and the fractionation zone 26.

With respect to the intermediate conversion, the HM precursor-comprising feed material 12 is converted to a GEM-comprising intermediate product 16 within an intermediate conversion zone 19. In this respect, the converting includes converting the HM precursor-comprising feed material 12 to a GEM-comprising intermediate product 16 within the intermediate conversion zone 19. The converting of the HM precursor-comprising feed material 12 to a GHM-comprising intermediate product 16 includes reactive transformation of at least a portion of the HM precursor-comprising feed material 12. The reactive transformation of at least a portion of the HM precursor-comprising feed material 12 is effected by a reactive process within a reaction zone 19A of the intermediate conversion zone 19. In this respect, the intermediate conversion includes reactive transformation of at least a portion of the HM precursor-comprising feed material 12 via a reactive process within the reaction zone 19A of the intermediate conversion zone 19. An exemplary reactive process is pyrolysis (high temperature decomposition). Exemplary reactive processes occurring during pyrolysis include decarbonylation, decarboxylation, thermal cracking, and condensation or any combination thereof. During pyrolysis, oxygen groups are remo6ved via decarboxylation and decarbonylation and the long chain hydrocarbons are cracked into the smaller chain molecules that comprise naphtha and diesel. The products of the pyrolysis include the GEM-comprising product 14 and a liquid hydrocarbon material-comprising product 42. In some embodiments, for example, the GHM-comprising product 14 includes the GHM, the FA material, carbon monoxide, carbon dioxide, methane, ethane, propane, and diatomic hydrogen. In some embodiments, for example, the liquid hydrocarbon material-comprising product 42 includes liquid hydrocarbon compounds, such as, for example, liquid hydrocarbon compounds containing a total number of six (6) to 16 carbon atoms, free fatty acid compounds containing a total number of four (4) to 18 carbon atoms, water, and a solid carbon by-product made up of high molecular weight species such as large, polycyclic aromatics. In some embodiments, for example, the reactive process is effected in the absence of a catalyst. In some embodiments, for example, the reactive process is effected in the absence of adscititious diatomic hydrogen. In some embodiments, for example, the reactive process is effected in the absence of adscititious diatomic oxygen. In some embodiments, for example, the reactive process is effected in the absence of a catalyst and in the absence of adscititious diatomic hydrogen. In some embodiments, for example, the reactive process is effected in the absence of a catalyst, and in the absence of adscititious diatomic hydrogen, and in the absence of adscititious diatomic oxygen. In some embodiments, for example, the conversion zone and the supplying of the hydrocarbon material precursor-comprising feed material to the reaction zone 19A co-operate such that the space time, defined by the time required by the supplied hydrocarbon material precursor-comprising feed material to occupy the entirety of the reaction zone 19A, is at least 10 minutes, such as, for example, at least 15 minutes. In some embodiments, for example, the reaction zone 19A and the supplying of the hydrocarbon material precursor-comprising feed material to the conversion zone 10 co-operate such that the space time, defined by the time required by the supplied hydrocarbon material precursor-comprising feed material to occupy the entirety of the reaction zone 19A, is from ten (10) minutes to 120 minutes, such as, for example, from ten (10) minutes to 90 minutes. In some embodiments, for example, the temperature within the reaction zone 18 is from 350 degrees Celsius to 500 degrees Celsius, such as, for example, from 360 degrees Celsius to 450 degrees Celsius. In some embodiments, for example, the pressure within the reaction zone 18 is from 100 to 250 psig.

With respect to the fractionation, the GEM-comprising intermediate product 16 is fractionated within a fractionating zone 26 with effect that the GEM-comprising product 14 is obtained. In this respect, the converting includes fractionating the GEM-comprising intermediate product 16 within the fractionating zone 26 with effect that the GEM-comprising product 14 is obtained. In some embodiments, for example, the fractionation is effected in response to contacting, within the fractionation zone 26, of the GEM-comprising intermediate product 16 with the above-described reflux 28. In some embodiments, for example, while the contacting between the reflux 28 and the GEM-comprising intermediate product 16 is being effected, the reflux 28 is being flowed in an opposite direction relative to the flow of the GHM-comprising intermediate product 16. In this respect, in some embodiments, for example, the fractionating is effected in response to contacting of the reflux 28 and the GEM-comprising intermediate product 16 while the reflux 28 is flowing countercurrent to the flow of the GHM-comprising intermediate product 16. In some embodiments, for example, the flow of the GHM-comprising intermediate product 16 is in an upwardly direction and the flow of the reflux 28 is in a downwardly direction. In some of these embodiments, for example, the contacting between the GEM-comprising intermediate product 16 and the reflux 28 is encouraged by contacting media disposed within the fractionation zone 26. Suitable contacting media includes trays, plates, and packing.

In some of these embodiments, for example, the process is a continuous process and, in this respect, the process includes, while: (i) a HM precursor-comprising feed material 12 is being supplied to the intermediate conversion zone 19, with effect that the HM precursor-comprising feed material 12 is converted to at least a GEM-comprising intermediate product 16, (ii) the GEM-comprising intermediate product 16 is being emplaced within the fractionation zone 26, (iii) a portion of a GEM-comprising product 14 is being condensed such that a condensed HM-comprising product is obtained 28, and (v) the condensed HM-comprising product 28 is recycled to the fractionation zone 26:
within the fractionation zone 26, contacting the GEM-comprising intermediate product 16 with the condensed HM-comprising product 28, with effect that the GEM-comprising intermediate product is fractionated, such that the GEM-comprising product 14 is obtained.

Referring to FIG. 3, the condensing of the portion of the GEM-comprising product 14 is with effect that a condensed portion is separated from the GEM-comprising product 14, such that a short chain hydrocarbon-enriched product 32 is obtained. The shorter chain hydrocarbon-enriched product 32 is cooled within a heat exchanger 34, with effect that a condensed liquid material 36, including liquid hydrocarbon material product 66 and water 67, is produced. The condensed liquid material 36 is supplied to a decanter 38, where the water 67 is separated from the liquid hydrocarbon material 66. In some embodiments, for example, the uncondensed gas 40, from the shorter chain hydrocarbon-enriched product 32, is vented or combusted.

As discussed above, in some embodiments, for example, the converting of the HM precursor-comprising feed material 12 is with effect that the liquid hydrocarbon material-comprising product 42 is obtained. Referring to FIGS. 4 to 7, in some of these embodiments, for example, the liquid hydrocarbon material-comprising product 42 is recovered from the conversion zone 10. In this respect, in some embodiments, for example, the process includes, within a conversion zone 10, converting the HM precursor-comprising feed material 12 to at least the GEM-comprising product 14 and the liquid hydrocarbon material-comprising product 42, and separating the GEM-comprising product 14 from the liquid hydrocarbon material-comprising product 42. In some embodiments, for example, the separating of the GHM-comprising product 14 from the liquid hydrocarbon material-comprising product 42 includes a gravity separation and is effected in response to at least buoyancy forces.

In those embodiments where the converting includes an intermediate conversion, where the HM precursor-comprising feed material 12 is converted to at least a GEM-comprising intermediate product 16 within an intermediate conversion zone 19, and also includes a second conversion, where the GEM-comprising intermediate product 16 is fractionated within a fractionating zone 26 with effect that the GEM-comprising product 14 is obtained, in some of these embodiments, for example, the intermediate conversion effects production of the liquid hydrocarbon material-comprising product 42. In this respect, in some of these embodiments, the process further includes separating the GEM-comprising intermediate product 16 from the liquid hydrocarbon material-comprising product 42. In some embodiments, for example, the separating of the GEM-comprising intermediate product 16 from the liquid hydrocarbon material-comprising product 42 includes a gravity separation and is effected in response to at least buoyancy forces.

In some embodiments, for example, an intermediate material mixture 24 is disposed within the intermediate conversion zone 19 and includes reaction products (resulting from the reactive transformation) and unreacted HM precursor-comprising feed material 12. At least a portion of the unreacted HM precursor-comprising feed material 12 is reactively transformable into reaction products, as described above.

In those embodiments where the GEM-comprising intermediate product 16 is separated from the liquid hydrocarbon material-comprising product 42, in some of these embodiments, for example, the separation is effected by separation of the intermediate material mixture 24 into at least the GEM-comprising intermediate product 16 and the liquid hydrocarbon material-comprising product 42, and the separation includes a gravity separation and is effected in response to at least buoyancy forces.

In some of these embodiments, for example, the process is a continuous process and, in this respect, the process includes, while: (i) the intermediate material mixture 24 is disposed within the intermediate conversion zone 19, and (ii) the HM precursor-comprising feed material 12 is being supplied to the intermediate conversion zone 10, independently:
separating the intermediate material mixture 24 into at least the GEM-comprising intermediate product 16 and the liquid hydrocarbon material-comprising product 42.

In some embodiments, for example, the separated liquid hydrocarbon material-comprising product 42 is discharged from the process vessel 20. At least a portion of the discharged liquid hydrocarbon material-comprising product 42 is recirculated externally of the internal space 21 via a pump 60. In this respect, in some embodiments, for example, a recirculation loop 62 is provided for recirculating at least a portion of the discharging liquid hydrocarbon material-comprising product 42 externally of the internal space 21 such that the discharged liquid hydrocarbon material-comprising product 42 is returned to the internal space 21 of the process vessel 20, such that the converting of the HM-precursor-comprising feed material, within the internal space 21 of the process vessel 20, is effected, as above described. In this respect, in some embodiments, the intermediate conversion zone 19 includes the recirculation loop 62. The residual liquid material product 58, which is not recirculated, can be further processed.

Referring to FIGS. 4, 5, 7, and 8, in some embodiments, for example, the recirculation loop 62 includes a heat exchanger 44 for effecting heating of the material (such as, for example, at least a portion of the liquid hydrocarbon material-comprising product 42) that is recirculating within the recirculation loop 62, such that recirculating heated material 50 is obtained. In some embodiments, for example, the heat exchanger 44 includes a molten salt bath. In some embodiments, for example, the heated recirculating material 50 supplies heat for encouraging the conversion of the HM precursor-comprising feed material 12, in those embodiments where the feed material-receiving zone 21A is disposed within the process vessel 20. By effecting heat transfer communication of the liquid hydrocarbon material-comprising product 42, being recirculated externally of the internal space 21 via the recirculation loop 62, with a heating source, as opposed to heat transfer communication of the liquid hydrocarbon material-comprising product 42, disposed within the internal space 21, with a heating source via the walls of process vessel 20, scaling of the walls is mitigated. In some of these embodiments, for example, instead of being supplied to the internal space 21 of the process vessel 20, the HM-precursor-comprising feed material 12 is supplied to the recirculation loop 62, such that the feed material-receiving zone 21A of the intermediate conversion zone 19 is defined within the recirculation loop 62, as opposed to the internal space 21 of the process vessel 20, such that the converting of the HM-precursor-comprising feed material 12, within the internal space 21, is effected, as above described.

In some embodiments, for example, the process, including the recirculation of the discharged liquid hydrocarbon material-comprising product 42, is continuous. In this respect, in some embodiments, for example, the process includes, while: (i) within an internal space 21 of the process vessel 20, converting the HM precursor to an intermediate material mixture 24, wherein the converting includes reactive transformation of at least a portion of the HM precursor via a reactive process within a reaction zone 18; (ii) in response to at least buoyancy forces, separating the intermediate material mixture 24 into a GEM-comprising product 14 and a liquid hydrocarbon material-comprising product 42; (iii) discharging the separated liquid hydrocarbon material-comprising product 42 from the process vessel 20 such that an externally-disposed liquid hydrocarbon material-comprising product 42 is obtained; and (iv) recirculating at least a portion 50 of the externally-disposed liquid hydrocarbon material-comprising product 42 to the internal space 21 of the process vessel 20:
heating the recirculating externally-disposed liquid hydrocarbon material-comprising product 50.

Referring to FIG. 6, in some embodiments, for example, the recirculation loop 62 includes a solids removal unit operation 56 for effecting removal of at least a fraction of solid material that is entrained within the discharged liquid hydrocarbon material-comprising product 42 that is being recirculated within the recirculation loop 62, with effect that a solids-depleted liquid material 52 is produced. Exemplary solids removal unit operations include one or more of filtration, hydrocyclone, and centrifugation.

Referring to FIG. 7, in those embodiments where the recirculation loop includes a heat exchanger 44, in some of these embodiments, prior to conducting the recirculating liquid material product through the heat exchanger 44, at least a fraction of solid material, which is entrained within the recirculating liquid material product, is removed from the recirculating liquid material product, with effect that a solids-depleted recirculating material 52 is obtained. In this respect, the solids-depleted recirculating material 52 is circulated through the heat exchanger 44, with effect that the heated recirculating material 50 is defined by a heated solids-depleted liquid material product.

Referring to FIG. 8, in some embodiments, for example, the residual liquid material product 58, is separated into a recoverable gaseous material portion 64 and a rejectable residual slurry material portion 66. The recoverable gaseous material portion 64 is recovered and supplied to the recirculation loop 62, upstream of the pump 60, for supply to the internal space 21 of the process vessel 20.

With respect to the separation, in some embodiments, for example, the residual liquid material product 58 is fractionated into the recoverable gaseous material portion 64 and the rejectable residual slurry material portion 66 in response to heating of the residual liquid material product 58. In this respect, the fractionation is based on volatility differences, fractionating at least a portion of the externally-disposed liquid hydrocarbon material-comprising product into a recoverable gaseous material portion and a rejected residual slurry material portion. In some embodiments, for example, the heating is effected under vacuum conditions. In this respect, in some embodiments, for example, the heating is effected within a heating zone 68 disposed at a temperature from 250 degrees Celsius to 350 degrees Celsius and at a pressure that is less than atmospheric pressure, such as, for example, at a pressure from 0.0725 psia (0.5 kPa) to 0.725 psia (5 kPa).

In some embodiments, for example, in response to the heating of the residual liquid material product 58 within the heating zone 68, a product mixture 70 is generated within the conversion zone 68, such that the product mixture 70 is disposed within the heating zone 68. The product mixture 70 includes the recoverable gaseous material portion 64 and the rejectable residual slurry material portion 66. While the product mixture 70 is disposed within the conversion zone 68, in response to buoyancy forces, the product mixture 70 is separated into the recoverable gaseous material portion 64 and the rejectable residual slurry material portion 66.

In some embodiments, for example, the heating zone 68 is disposed within a process vessel 72, such that: (i) the recoverable gaseous material portion 64 accumulates at an upper portion 74 of the process vessel 72 and discharged as a recovered gaseous material portion 64A, and (ii) the rejectable residual slurry material portion 66 accumulates at a bottom portion 76 of the process vessel 74 and discharged as a rejected residual slurry material portion 66A, In some embodiments, for example, the discharging of the recovered gaseous material portion 64A is induced by a vacuum pump 78 disposed in flow communication with the upper portion 74 of the process vessel 70.

In some embodiments, for example, the process vessel 70 is a thin film evaporator.

In some embodiments, for example, prior to the supplying of the residual liquid material product 58 to the heating zone 68, the residual liquid material product 58 is cooled within a heat exchanger 86, so as to further mitigate coke formation.

In some embodiments, for example, by separating the rejected residual slurry material portion 66A from the recovered gaseous material portion 66A, coke formation within the system is mitigated. In this respect, the rejected residual slurry material portion 66A includes materials, such as long chain hydrocarbons and solids, which are susceptible to coke formation in response to exposure to high temperatures, and their removal effects the mitigation of coke formation.

With respect to the discharged recovered gaseous material portion 64A, in some embodiments, for example, the discharged recovered gaseous material portion 64A is condensed, within a condensation zone 82 of a condenser 80, to generate a condensed recovered residual material 64B. In some embodiments, for example, the condensation within the condensation zone 82 is with effect that condensed recovered residual material 64B is disposed at a temperature from 150 degrees Celsius to 200 degrees Celsius and at a pressure from 100 psig to 250 psig (for example, to match the pressure conditions within the process vessel 20, to which the condensed recovered residual material 64B is supplied, see below).

With respect to the condensed recovered residual material 64B, the condensed recovered residual material 64B is supplied to the internal space 21 of the process vessel 20 such that the converting of the condensed recovered residual material 64B, within the internal space 21, is effected, as above described.

In some embodiments, for example, prior to the supplying of the condensed recovered residual material 64B to the internal space 21 of the process vessel 20, the condensed recovered residual material 64B is heated, such that the condensed recovered residual material 64B is disposed at a temperature from 300 degrees Celsius to 400 degrees Celsius. In some embodiments, the heating includes emplacing the condensed recovered residual material 64B in heat transfer communication with the residual liquid material product 58 (such as, for example, via a heat exchanger), such that heat is transferred from the residual liquid material product 58 to the condensed recovered residual material 64B. In some embodiments, for example, the heating includes emplacing the condensed recovered residual material 64B in heat transfer communication with a heating fluid, such as via heat exchanger 84.

In some embodiments, prior to the supplying of the condensed recovered residual material 64B to the internal space 21 of the process vessel 20, the condensed recovered residual material 64B is admixed with material within the recirculation loop 62 for supply to the internal space 21 of the process vessel 20. In some of these embodiments, for example, prior to the admixing, the condensed recovered residual material 64B is heated (as above-described), such that the condensed recovered residual material 64B is disposed at a temperature from 300 degrees Celsius to 400 degrees Celsius. In some of these embodiments, for example, the material being recirculated within the recirculation loop 62 includes the HM-precursor-comprising feed material 12.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

What is claimed is:

1. A process for producing hydrocarbon material from a hydrocarbon material precursor which includes free fatty acid material, comprising:
supplying a hydrocarbon material precursor-comprising feed material to a conversion zone, with effect that the hydrocarbon material precursor-comprising feed material is converted to a gaseous hydrocarbon material-comprising product;
condensing a portion of the gaseous hydrocarbon material-comprising product such that a condensed hydrocarbon material-comprising product is obtained; and
recycling the condensed hydrocarbon material-comprising product to the conversion zone as a reflux;
wherein:
the condensing is effected in response to emplacement of the gaseous hydrocarbon material-comprising product in heat transfer communication with a heat sink disposed externally of the conversion zone.

2. The process as claimed in claim 1;
wherein:
the conversion zone is disposed within a process vessel; and
the emplacing of the gaseous hydrocarbon material-comprising product, in heat transfer communication with the heat sink, includes discharging of the gaseous hydrocarbon material-comprising product from the process vessel.

3. The process as claimed in claim 1 or 2;
wherein:
the converting includes reactive transformation of at least a portion of the hydrocarbon material precursor-comprising feed material via a reactive process within a reaction zone.

4. The process as claimed in claim 1 or 2;
wherein:
the converting includes:
within an intermediate conversion zone, converting the hydrocarbon material precursor-comprising feed material to a gaseous hydrocarbon material-comprising intermediate product, wherein the converting includes reactive transformation of at least a portion of the hydrocarbon material-comprising feed material via a reactive process within a reaction zone; and
within a fractionation zone, contacting the gaseous hydrocarbon material-comprising intermediate product with the reflux, with effect that fractionation of the gaseous hydrocarbon material-comprising intermediate product is effected, such that the gaseous hydrocarbon material-comprising product is obtained;
such that the conversion zone includes the intermediate conversion zone and the fractionation zone.

5. The process as claimed in claim 4;
wherein:
the fractionating zone includes contacting media for encouraging the contacting of the gaseous hydrocarbon material-comprising intermediate product with the reflux.

6. The process as claimed in any one of claims 3 to 5;
wherein:
at least one of: (i) the concentration of the gaseous hydrocarbon material within the gaseous hydrocarbon material-comprising product is greater than the concentration of the gaseous hydrocarbon material within the gaseous hydrocarbon material-comprising conversion zone product, and (ii) the ratio of the gaseous hydrocarbon material to the hydrocarbon material precursor, within the gaseous hydrocarbon material-comprising product, is greater than the ratio of the gaseous hydrocarbon material to the hydrocarbon material precursor within the gaseous hydrocarbon material-comprising conversion zone product.

7. The process as claimed in any one of claims 3 to 6;
wherein:
the reactive zone is disposed at a temperature from 350 degrees Celsius to 500 degrees Celsius.

8. The process as claimed in any one of claims 3 to 7;
wherein:
the reaction zone is disposed at a pressure from 150 psig to 250 psig.

9. The process as claimed in any one of claims 3 to 8;
wherein:
there is an absence of adscititious diatomic oxygen within the reaction zone.

10. The process as claimed in any one of claims 3 to 9;
wherein:
there is an absence of adscititious diatomic hydrogen within the reaction zone.

11. The process as claimed in any one of claims 3 to 10;
wherein:
there is an absence of decarboxylation catalyst within the reaction zone.

12. The process as claimed in any one of claims 3 to 11;
wherein:
the reactive process includes pyrolysis.

13. The process as claimed in any one of claims 3 to 12;
wherein:
the reaction zone and the supplying of the hydrocarbon material precursor-comprising feed material to the reaction zone co-operate such that the space time, defined by the time required by the supplied hydrocarbon material precursor-comprising feed material to occupy the entirety of the reaction zone, is at least ten (10) minutes.

14. The process as claimed in any one of claims 1 to 13;
wherein:
the fraction of the gaseous hydrocarbon material-comprising product which is being condensed and returned to the conversion zone defines a reflux ratio: and
the reflux ratio in based upon at least chain length of hydrocarbon material within the gaseous hydrocarbon material-comprising product.

15. The process as claimed in any one of claims 1 to 14;
wherein:
the fraction of the gaseous hydrocarbon material-comprising product which is being condensed and returned to the conversion zone defines a reflux ratio: and
the reflux ratio in based upon at least chain length of free fatty acid material within the condensed hydrocarbon material-comprising product.

16. The process as claimed in any one of claims 1 to 15;
wherein:
the process is continuous.

17. A process for producing hydrocarbon material from a hydrocarbon material precursor which includes free fatty acid material, comprising:
while: (i) a hydrocarbon material precursor-comprising feed material is being supplied to a conversion zone, (ii) the hydrocarbon material precursor-comprising feed material is being converted to a gaseous hydrocarbon material-comprising product within the conversion zone, and (iii) the gaseous hydrocarbon material-comprising product is being emplaced in heat transfer communication with a heat sink disposed externally of the conversion zone such that a portion of the gaseous hydrocarbon material-comprising product is condensed with effect that a condensed hydrocarbon material-comprising product is obtained externally of the conversion zone:
recycling the condensed hydrocarbon material-comprising product to the conversion zone.

18. The process as claimed in claim 17;
wherein:
the conversion zone is disposed within a process vessel; and
the emplacing of the gaseous hydrocarbon material-comprising product, in heat transfer communication with a heat sink, includes discharging of the gaseous hydrocarbon material-comprising product from the process vessel.

19. The process as claimed in claim 17 or 18;
wherein:
the converting includes reactive transformation of at least a portion of the hydrocarbon material precursor-comprising feed material by via a reactive process within a reaction zone.

20. The process as claimed in claim 17 or 18;
wherein:
the converting includes:
within an intermediate conversion zone, converting the hydrocarbon material precursor-comprising feed material to a gaseous hydrocarbon material-comprising intermediate product, wherein the converting includes reactive transformation of at least a portion of the hydrocarbon material-comprising feed material via a reactive process within a reaction zone; and
within a fractionation zone, contacting the gaseous hydrocarbon material-comprising intermediate product with the reflux, with effect that fractionation of the gaseous hydrocarbon material-comprising intermediate product is effected, such that the gaseous hydrocarbon material-comprising product is obtained;
such that the conversion zone includes the intermediate conversion zone and the fractionation zone.

21. The process as claimed in claim 20;
wherein:
the converting of the hydrocarbon material precursor-comprising feed material is being effected while the contacting of the gaseous hydrocarbon material-comprising intermediate product with the reflux is being effected.

22. The process as claimed in claim 20 or 21;
wherein:
the fractionating zone includes contacting media for encouraging the contacting of the gaseous hydrocarbon material-comprising intermediate product with the reflux.

23. The process as claimed in any one of claims 20 to 22;
wherein:
at least one of: (i) the concentration of the gaseous hydrocarbon material within the gaseous hydrocarbon material-comprising product is greater than the concentration of the gaseous hydrocarbon material within the gaseous hydrocarbon material-comprising conversion zone product, and (ii) the ratio of the gaseous hydrocarbon material to the hydrocarbon material precursor, within the gaseous hydrocarbon material-comprising product, is greater than the ratio of the gaseous hydrocarbon material to the hydrocarbon material precursor within the gaseous hydrocarbon material-comprising conversion zone product.

24. The process as claimed in any one of claims 19 to 23;
wherein:
the reactive zone is disposed at a temperature from 350 degrees Celsius to 500 degrees Celsius.

25. The process as claimed in any one of claims 19 to 24;
wherein:
the reaction zone is disposed at a pressure from 150 psig to 250 psig.

26. The process as claimed in any one of claims 19 to 25;
wherein:
there is an absence of adscititious diatomic oxygen within the reaction zone.

27. The process as claimed in any one of claims 19 to 26;
wherein:
there is an absence of adscititious diatomic hydrogen within the reaction zone.

28. The process as claimed in any one of claims 19 to 27;
wherein:
there is an absence of decarboxylation catalyst within the reaction zone.

29. The process as claimed in any one of claims 19 to 28;
wherein:
the reactive process includes pyrolysis.

30. The process as claimed in any one of claims 19 to 29;
wherein:
the reaction zone and the supplying of the hydrocarbon material precursor-comprising feed material to the reaction zone co-operate such that the space time, defined by the time required by the supplied hydrocarbon material precursor-comprising feed material to occupy the entirety of the reaction zone, is at least ten (10) minutes.

31. The process as claimed in any one of claims 17 to 30;
wherein:
the fraction of the gaseous hydrocarbon material-comprising product which is being condensed and recycled to the conversion zone defines a reflux ratio: and
the reflux ratio in based upon at least one parameter, and the at least one parameter includes at least one of: (i) chain length of hydrocarbon material within the gaseous hydrocarbon material-comprising product, and (ii) chain length of free fatty acid material within the gaseous hydrocarbon material-comprising product.

32. A process for producing hydrocarbon material from a hydrocarbon material precursor which includes free fatty acid material, comprising:
supplying a hydrocarbon material precursor-comprising feed material to a conversion zone, with effect that the hydrocarbon material precursor-comprising feed material flow is converted to a hydrocarbon material-comprising product;
recovering the hydrocarbon material-comprising product from the conversion zone; and
refluxing a portion of the recovered hydrocarbon material-comprising product to the conversion zone;
wherein:
the fraction of the recovered gaseous hydrocarbon material-comprising product which is being refluxed to the conversion zone defines a reflux ratio: and
the reflux ratio in based upon at least one sensed parameter, and the at least one sensed parameter includes at least one of: (i) chain length of hydrocarbon material within the gaseous hydrocarbon material-comprising product, and (ii) chain length of free fatty acid material within the gaseous hydrocarbon material-comprising product;
such that the process further comprises at least one of: (i) sensing of chain length of hydrocarbon material within the gaseous hydrocarbon material-comprising product, and (ii) sensing of chain length of free fatty acid material within the gaseous hydrocarbon material-comprising product.

33. The process as claimed in claim 32;
wherein:
the converting includes reactive transformation of at least a portion of the hydrocarbon material precursor-comprising feed material by via a reactive process within a reaction zone.

34. The process as claimed in claim 32;
wherein:
the converting includes:
within an intermediate conversion zone, converting the hydrocarbon material precursor-comprising feed material to a gaseous hydrocarbon material-comprising intermediate product, wherein the converting includes reactive transformation of at least a portion of the hydrocarbon material-comprising feed material via a reactive process within a reaction zone; and
within a fractionation zone, contacting the gaseous hydrocarbon material-comprising intermediate product with the reflux, with effect that fractionation of the gaseous hydrocarbon material-comprising intermediate product is effected, such that the gaseous hydrocarbon material-comprising product is obtained;
such that the conversion zone includes the intermediate conversion zone and the fractionation zone.

35. The process as claimed in claim 34;
wherein:
the fractionating zone includes contacting media for encouraging the contacting of the gaseous hydrocarbon material-comprising intermediate product with the reflux.

36. The process as claimed in any one of claim 34 or 35;
wherein:
at least one of: (i) the concentration of the gaseous hydrocarbon material within the gaseous hydrocarbon material-comprising product is greater than the concentration of the gaseous hydrocarbon material within the gaseous hydrocarbon material-comprising conversion zone product, and (ii) the ratio of the gaseous hydrocarbon material to the hydrocarbon material precursor, within the gaseous hydrocarbon material-comprising product, is greater than the ratio of the gaseous hydrocarbon material to the hydrocarbon material precursor within the gaseous hydrocarbon material-comprising conversion zone product.

37. The process as claimed in any one of claims 33 to 36;
wherein:
the reactive zone is disposed at a temperature from temperature from 350 degrees Celsius to 500 degrees Celsius.

38. The process as claimed in any one of claims 33 to 37;
wherein:
the reaction zone is disposed at a pressure from 150 psig to 250 psig.

39. The process as claimed in any one of claims 33 to 38;
wherein:
there is an absence of adscititious diatomic oxygen within the reaction zone.

40. The process as claimed in any one of claims 33 to 39;
wherein:
there is an absence of adscititious diatomic hydrogen within the reaction zone.

41. The process as claimed in any one of claims 33 to 40;
wherein:
there is an absence of decarboxylation catalyst within the reaction zone.

42. The process as claimed in any one of claims 33 to 41;
wherein:
the reactive process includes pyrolysis.

43. The process as claimed in any one of claims 33 to 42;
wherein:
the reaction zone and the supplying of the hydrocarbon material precursor-comprising feed material to the reaction zone co-operate such that the space time, defined by the time required by the supplied hydrocarbon material precursor-comprising feed material to occupy the entirety of the reaction zone, is at least ten (10) minutes.

44. The process as claimed in any one of claims 32 to 43;
wherein:
the reflux ratio is based upon at least sensing of chain length of hydrocarbon material within the hydrocarbon material-comprising product;
and further comprising:
sensing the chain length of hydrocarbon material within the hydrocarbon material-comprising product.

45. The process as claimed in claim 44;
further comprising:
modulating the reflux ratio based upon at least the sensing of the chain length of hydrocarbon material within the hydrocarbon material-comprising product.

46. The process as claimed in any one of claims 32 to 43;
wherein:
the reflux ratio is based upon at least sensing of chain length of free fatty acid material within the hydrocarbon material-comprising product;
and further comprising:
sensing the chain length of free fatty acid material within the hydrocarbon material-comprising product.

47. The process as claimed in claim 46;
further comprising:
modulating the reflux ratio based upon at least the sensing of the chain length of free fatty acid material within the hydrocarbon material-comprising product.

48. The process as claimed in any one of claims 32 to 43;
wherein:
the reflux ratio is based upon at least: (i) sensing of chain length of hydrocarbon material within the hydrocarbon material-comprising product, and (ii) sensing of chain length of free fatty acid material within the hydrocarbon material-comprising product;
and further comprising:
sensing the hydrocarbon material-comprising product for the chain length of hydrocarbon material within the hydrocarbon material-comprising product; and
sensing the hydrocarbon material-comprising product for the chain length of free fatty acid material within the hydrocarbon material-comprising product.

49. The process as claimed in claim 48;
further comprising:
modulating the reflux ratio based upon at least:
(i) sensing of chain length of hydrocarbon material within the hydrocarbon material-comprising product;
(ii) sensing of chain length of free fatty acid material within the hydrocarbon material-comprising product; or
(iii) sensing of chain length of hydrocarbon material within the hydrocarbon material-comprising product and sensing of chain length of free fatty acid material within the hydrocarbon material-comprising product.

50. The process as claimed in any one of claims 32 to 49;
wherein:
the refluxing includes:
condensing a portion of the gaseous hydrocarbon material-comprising product; and
recycling the condensed portion of the gaseous hydrocarbon material-comprising product to the conversion zone as the reflux.

51. The process as claimed in any one of claims 32 to 50;
wherein:
the process is continuous.

52. A process for producing hydrocarbon material from a hydrocarbon material precursor which includes free fatty acid material, comprising:
while: (i) a hydrocarbon material precursor-comprising feed material is being supplied to a conversion zone, (ii) the hydrocarbon material precursor-comprising feed material is being converted to a hydrocarbon material-comprising product within the conversion zone, (iii) the hydrocarbon material-comprising product is being recovered from the conversion zone; and (iv) the recovered hydrocarbon material-comprising product is being monitored for at least one of:
(a) chain length of hydrocarbon material within the gaseous hydrocarbon material-comprising product, and (b) chain length of free fatty acid material within the gaseous hydrocarbon material-comprising product:
refluxing at least a portion of the recovered hydrocarbon material-comprising product to the conversion zone based on at least the monitoring.

53. The process as claimed in claim 52;
wherein:
the converting includes reactive transformation of at least a portion of the hydrocarbon material precursor-comprising feed material by via a reactive process within a reaction zone.

54. The process as claimed in claim 52;
wherein:
the converting includes:
within an intermediate conversion zone, converting the hydrocarbon material precursor-comprising feed material to a gaseous hydrocarbon material-comprising intermediate product, wherein the converting includes reactive transformation of at least a portion of the hydrocarbon material-comprising feed material via a reactive process within a reaction zone; and
within a fractionation zone, contacting the gaseous hydrocarbon material-comprising intermediate product with the reflux, with effect that fractionation of the gaseous hydrocarbon material-comprising intermediate product is effected, such that the gaseous hydrocarbon material-comprising product is obtained;
such that the conversion zone includes the intermediate conversion zone and the fractionation zone.

55. The process as claimed in claim 54;
wherein:
the fractionating zone includes contacting media for encouraging the contacting of the hydrocarbon material-comprising intermediate product with the reflux.

56. The process as claimed in any one of claim 54 or 55;
wherein:
at least one of: (i) the concentration of the gaseous hydrocarbon material within the gaseous hydrocarbon material-comprising product is greater than the concentration of the gaseous hydrocarbon material within the gaseous hydrocarbon material-comprising intermediate product, and (ii) the ratio of the hydrocarbon material to the hydrocarbon material precursor, within the hydrocarbon material-comprising product, is greater than the ratio of the hydrocarbon material to the hydrocarbon material precursor within the hydrocarbon material-comprising intermediate product.

57. The process as claimed in any one of claims 53 to 56;
wherein:
the reactive zone is disposed at a temperature from temperature from 350 degrees Celsius to 500 degrees Celsius.

58. The process as claimed in any one of claims 53 to 57;
wherein:
the reaction zone is disposed at a pressure from 150 psig to 250 psig.

59. The process as claimed in any one of claims 53 to 58;
wherein:
there is an absence of adscititious diatomic oxygen within the reaction zone.

60. The process as claimed in any one of claims 53 to 59;
wherein:
there is an absence of adscititious diatomic hydrogen within the reaction zone.

61. The process as claimed in any one of claims 53 to 60;
wherein:
there is an absence of decarboxylation catalyst within the reaction zone.

62. The process as claimed in any one of claims 53 to 61;
wherein:
the reactive process includes pyrolysis.

63. The process as claimed in any one of claims 53 to 62;;
wherein:
the reaction zone and the supplying of the hydrocarbon material precursor-comprising feed material to the reaction zone co-operate such that the space time, defined by the time required by the supplied hydrocarbon material precursor-comprising feed material to occupy the entirety of the reaction zone, is at least ten (10) minutes.

64. The process as claimed in any one of claims 52 to 63;
wherein:
the refluxing includes:
condensing a portion of the hydrocarbon material-comprising product; and
recycling the condensed portion of the hydrocarbon material-comprising product to the conversion zone as the reflux.

65. The process as claimed in any one of claims 52 to 64;
wherein:
the monitoring includes monitoring of the recovered hydrocarbon material-comprising product for chain length of hydrocarbon material within the hydrocarbon material-comprising product, and the monitoring includes sensing of chain length of hydrocarbon material within the hydrocarbon material-comprising product;
and further comprising:
while: (i) the hydrocarbon material precursor-comprising feed material is being supplied to a conversion zone, (ii) the hydrocarbon material precursor-comprising feed material is being converted to a hydrocarbon material-comprising product within the conversion zone, (iii) the hydrocarbon material-comprising product is being recovered from the conversion zone; (iv) the recovered hydrocarbon material-comprising product is being monitored for chain length of hydrocarbon material within the gaseous hydrocarbon material-comprising product, (v) at least a portion of the recovered hydrocarbon material-comprising product is being refluxed to the conversion zone based on at least the monitoring, and (vi) a change, in chain length of hydrocarbon material within the gaseous hydrocarbon material-comprising product, is being sensed:
modulating the reflux ratio in response to at least the sensing of the change.

66. The process as claimed in any one of claims 52 to 64;
wherein:
the monitoring includes monitoring of the recovered hydrocarbon material-comprising product for chain length of free fatty acid material within the hydrocarbon material-comprising product, and the monitoring includes sensing of chain length of free fatty acid material within the hydrocarbon material-comprising product;
and further comprising:
while: (i) the hydrocarbon material precursor-comprising feed material is being supplied to a conversion zone, (ii) the hydrocarbon material precursor-comprising feed material is being converted to a hydrocarbon material-comprising product within the conversion zone, (iii) the hydrocarbon material-comprising product is being recovered from the conversion zone; (iv) the recovered hydrocarbon material-comprising product is being monitored for chain length of free fatty acid material within the hydrocarbon material-comprising product; (v) at least a portion of the recovered hydrocarbon material-comprising product is being refluxed to the conversion zone based on at least the monitoring, and (vi) a change, in chain length of free fatty acid material within the gaseous hydrocarbon material-comprising product, is being sensed:
modulating the reflux ratio in response to at least the sensing of the change.

67. The process as claimed in any one of claims 52 to 64;
wherein:
the monitoring is monitoring of the recovered hydrocarbon material-comprising product for chain length of hydrocarbon material within the gaseous hydrocarbon material-comprising product, and for chain length of free fatty acid material within the gaseous hydrocarbon material-comprising product, and the monitoring includes sensing of chain length of hydrocarbon material within the hydrocarbon material-comprising product and sensing of chain length of free fatty acid material within the hydrocarbon material-comprising product;
and further comprising:
while: (i) the hydrocarbon material precursor-comprising feed material is being supplied to a conversion zone, (ii) the hydrocarbon material precursor-comprising feed material is being converted to a hydrocarbon material-comprising product within the conversion zone, (iii) the hydrocarbon material-comprising product is being recovered from the conversion zone; (iv) the recovered hydrocarbon material-comprising product is being monitored for chain length of hydrocarbon material within the hydrocarbon material-comprising product and for chain length of free fatty acid material within the hydrocarbon material-comprising product, (v) at least a portion of the recovered hydrocarbon material-comprising product is being refluxed to the conversion zone based on at least the monitoring, and (vi) a change, in at least one of: (a) chain length of hydrocarbon material within the hydrocarbon material-comprising product, and (b) change in chain length of free fatty acid material within the hydrocarbon material-comprising product, is being sensed:
modulating the reflux ratio in response to at least the sensing of the change.

68. A process for producing hydrocarbon material from a hydrocarbon material precursor which includes free fatty acid material, comprising:
within an internal space of a process vessel, converting the hydrocarbon material precursor to an intermediate material mixture, wherein the converting includes reactive transformation of at least a portion of the hydrocarbon material precursor via a reactive process within a reaction zone;
in response to at least buoyancy forces, separating the intermediate material mixture into at least a gaseous hydrocarbon material-comprising product and a liquid hydrocarbon material-comprising product;
discharging the separated liquid hydrocarbon material-comprising product from the process vessel such that an externally-disposed liquid hydrocarbon material-comprising product is obtained;
admixing at least a portion of the externally-disposed liquid hydrocarbon material-comprising product with a hydrocarbon material precursor-comprising feed such that a combined material is obtained;
supplying the combined feed material to the reaction zone; and
co-operatively emplacing a heating source relative to the at least a portion of the externally-disposed liquid hydrocarbon material-comprising product and the hydrocarbon material precursor-comprising feed, such that, prior to the supplying of the combined feed material to the reaction zone, heating of both of the at least a portion of the externally-disposed liquid hydrocarbon material-comprising product and the hydrocarbon material precursor-comprising feed, by the heating source, is effected.

69. The process as claimed in claim 68;
wherein:
the co-operative emplacement of the heating source includes an emplacement of the heating source relative to the combined feed material such that the combined feed material is heated by the heating source.

70. The process as claimed in claim 69;
wherein:
both of the at least a portion of the externally-disposed liquid hydrocarbon material-comprising product and the hydrocarbon material precursor-comprising feed are heated by the heating source only after the admixing.

71. The process as claimed in claim 68;
wherein:
the co-operative emplacement of the heating source includes emplacement of the heating source relative to the hydrocarbon material precursor-comprising feed, such that:
prior to the admixing, the hydrocarbon material precursor-comprising feed is heated by the heating source; and
the at least a portion of the externally-disposed liquid hydrocarbon material-comprising poduct is heated in response to the admixing with the hydrocarbon material precursor-comprising feed.

72. The process as claimed in claim 71;
wherein:
prior to the admixing, only the hydrocarbon material precursor-comprising feed is heated by the heating source.

73. The process as claimed in claim 68;
wherein:
the co-operative emplacement of the heating source includes emplacement of the heating source relative to the at least a portion of the externally-disposed liquid hydrocarbon material-comprising product, such that:
prior to the admixing, the at least a portion of the externally-disposed liquid hydrocarbon material-comprising product is heated by the heating source; and
the hydrocarbon material precursor-comprising feed is heated in response to the admixing with the externally-disposed liquid hydrocarbon material-comprising product.

74. The process as claimed in claim 73;
wherein:
prior to the admixing, only the at least a portion of the externally-disposed liquid hydrocarbon material-comprising product is heated by the heating source.

75. The process as claimed in any one of claims 68 to 74;
wherein:
the heating by the heating source includes an indirect heating.

76. The process as claimed in any one of claims 68 to 75;
wherein:
the reactive zone is disposed at a temperature from temperature from 350 degrees Celsius to 500 degrees Celsius.

77. The process as claimed in any one of claims 68 to 76;
wherein:
the reaction zone is disposed at a pressure from 150 psig to 250 psig.

78. The process as claimed in any one of claims 68 to 77;
wherein:
there is an absence of adscititious diatomic oxygen within the reaction zone.

79. The process as claimed in any one of claims 68 to 78;
wherein:
there is an absence of adscititious diatomic hydrogen within the reaction zone.

80. The process as claimed in any one of claims 68 to 79;
wherein:
there is an absence of decarboxylation catalyst within the reaction zone.

81. The process as claimed in any one of claims 68 to 80;
wherein:
the reactive process includes pyrolysis.

82. The process as claimed in any one of claims 68 to 81;
wherein the process is continuous.

83. A process for producing hydrocarbon material from a hydrocarbon material precursor which includes free fatty acid material, comprising:
while: (i) within an internal space of a process vessel, converting the hydrocarbon material precursor to an intermediate material mixture, wherein the converting includes reactive transformation of at least a portion of the hydrocarbon material precursor via a reactive process within a reaction zone; (ii) in response to at least buoyancy forces, separating the intermediate material mixture into at least a gaseous hydrocarbon material-comprising product and a liquid hydrocarbon material-comprising product; (iii) discharging the separated liquid hydrocarbon material-comprising product from the process vessel such that an externally-disposed liquid hydrocarbon material-comprising product is obtained; (iv) admixing at least a portion of the externally-disposed liquid hydrocarbon material-comprising product with a hydrocarbon material precursor-comprising feed such that a combined material is obtained; and (v) supplying the combined feed material to the reaction zone;
co-operatively emplacing a heating source relative to the at least a portion of the externally-disposed liquid hydrocarbon material-comprising product and the hydrocarbon material precursor-comprising feed, such that, prior to the supplying of the combined feed material to the reaction zone, heating of both of the at least a portion of the externally-disposed liquid hydrocarbon material-comprising product and the hydrocarbon material precursor-comprising feed, by the heating source, is effected.

84. The process as claimed in claim 83;
wherein:
the co-operative emplacement of the heating source includes an emplacement of the heating source relative to the combined feed material such that the combined feed material is heated by the heating source.

85. The process as claimed in claim 84;
wherein:
both of the at least a portion of the externally-disposed liquid hydrocarbon material-comprising product and the hydrocarbon material precursor-comprising feed are heated by the heating source only after the admixing.

86. The process as claimed in claim 83;
wherein:
the co-operative emplacement of the heating source includes emplacement of the heating source relative to the hydrocarbon material precursor-comprising feed, such that:
prior to the admixing, the hydrocarbon material precursor-comprising feed is heated by the heating source; and
the at least a portion of the externally-disposed liquid hydrocarbon material-comprising product is heated in response to the admixing with the hydrocarbon material precursor-comprising feed.

87. The process as claimed in claim 86;
wherein:
prior to the admixing, only the hydrocarbon material precursor-comprising feed is heated by the heating source.

88. The process as claimed in claim 83;
wherein:
the co-operative emplacement of the heating source includes emplacement of the heating source relative to the at least a portion of the externally-disposed liquid hydrocarbon material-comprising product, such that:
prior to the admixing, the at least a portion of the externally-disposed liquid hydrocarbon material-comprising product is heated by the heating source; and
the hydrocarbon material precursor-comprising feed is heated in response to the admixing with the externally-disposed liquid hydrocarbon material-comprising product.

89. The process as claimed in claim 88;
wherein:
prior to the admixing, only the at least a portion of the externally-disposed liquid hydrocarbon material-comprising product is heated by the heating source.

90. The process as claimed in any one of claims 83 to 89;
wherein:
the heating by the heating source includes an indirect heating.

91. The process as claimed in any one of claims 83 to 90;
wherein:
the reactive zone is disposed at a temperature from temperature from 350 degrees Celsius to 500 degrees Celsius.

92. The process as claimed in any one of claims 83 to 91;
wherein:
the reaction zone is disposed at a pressure from 150 psig to 250 psig.

93. The process as claimed in any one of claims 83 to 92;
wherein:
there is an absence of adscititious diatomic oxygen within the reaction zone.

94. The process as claimed in any one of claims 83 to 93;
wherein:
there is an absence of adscititious diatomic hydrogen within the reaction zone.

95. The process as claimed in any one of claims 83 to 94;
wherein:
there is an absence of decarboxylation catalyst within the reaction zone.

96. The process as claimed in any one of claims 83 to 95;
wherein:
the reactive process includes pyrolysis.

97. A process for producing hydrocarbon material from a hydrocarbon material precursor which includes free fatty acid material, comprising:
within an internal space of a process vessel, converting the hydrocarbon material precursor to an intermediate material mixture, wherein the converting includes reactive transformation of at least a portion of the hydrocarbon material precursor via a reactive process within a reaction zone;
in response to at least buoyancy forces, separating the intermediate material mixture into at least a gaseous hydrocarbon material-comprising product and a liquid hydrocarbon material-comprising product;
discharging the separated liquid hydrocarbon material-comprising product from the process vessel such that an externally-disposed liquid hydrocarbon material-comprising product is obtained;
heating at least a portion of the externally-disposed liquid hydrocarbon material-comprising product to obtain a heated externally-disposed liquid hydrocarbon material-comprising product; and
supplying at least a portion of the heated externally-disposed liquid hydrocarbon material-comprising product to the reaction zone.

98. The process as claimed in claim 97;
wherein:
the heating by the heating source includes an indirect heating.

99. The process as claimed in claim 97 or 98;
wherein:
the reactive zone is disposed at a temperature from temperature from 350 degrees Celsius to 500 degrees Celsius.

100. The process as claimed in any one of claims 97 to 99;
wherein:
the reaction zone is disposed at a pressure from 150 psig to 250 psig.

101. The process as claimed in any one of claims 97 to 100;
wherein:
there is an absence of adscititious diatomic oxygen within the reaction zone.

102. The process as claimed in any one of claims 97 to 101;
wherein:
there is an absence of adscititious diatomic hydrogen within the reaction zone.

103. The process as claimed in any one of claims 97 to 102;
wherein:
there is an absence of decarboxylation catalyst within the reaction zone.

104. The process as claimed in any one of claims 97 to 103;
wherein:
the reactive process includes pyrolysis.

105. The process as claimed in any one of claims 97 to 104;
further comprising:
for at least the at least a portion of the externally-disposed liquid hydrocarbon material-comprising product, removing solid material from the at least a portion of the externally-disposed liquid hydrocarbon material-comprising product, such that the externally-disposed liquid hydrocarbon material-comprising product, being heated and supplied to the reaction zone, is depleted in solids relative to the externally-disposed liquid hydrocarbon material-comprising product being discharged from the process vessel.

106. The process as claimed in any one of claims 97 to 105;
wherein the process is continuous.

107. A process for producing hydrocarbon material from a hydrocarbon material precursor which includes free fatty acid material, comprising:
while: (i) within an internal space of a process vessel, converting the hydrocarbon material precursor to an intermediate material mixture, wherein the converting includes reactive transformation of at least a portion of the hydrocarbon material precursor via a reactive process within a reaction zone; (ii) in response to at least buoyancy forces, separating the intermediate material mixture into at least a gaseous hydrocarbon material-comprising product and a liquid hydrocarbon material-comprising product; (iii) discharging the separated liquid hydrocarbon material-comprising product from the process vessel such that an externally-disposed liquid hydrocarbon material-comprising product is obtained; and (iv) recirculating at least a portion of the externally-disposed liquid hydrocarbon material-comprising product to the reaction zone;
heating the recirculating externally-disposed liquid hydrocarbon material-comprising product.

108. The process as claimed in claim 107;
wherein:
the heating by the heating source includes an indirect heating.

109. The process as claimed in claim 107 or 108;
wherein:
the reactive zone is disposed at a temperature from temperature from 350 degrees Celsius to 500 degrees Celsius.

110. The process as claimed in any one of claims 107 to 109;
wherein:
the reaction zone is disposed at a pressure from 150 psig to 250 psig.

111. The process as claimed in any one of claims 107 to 110;
wherein:
there is an absence of adscititious diatomic oxygen within the reaction zone.

112. The process as claimed in any one of claims 107 to 111;
wherein:
there is an absence of adscititious diatomic hydrogen within the reaction zone.

113. The process as claimed in any one of claims 107 to 112;
wherein:
there is an absence of decarboxylation catalyst within the reaction zone.

114. The process as claimed in any one of claims 107 to 113;
wherein:
the reactive process includes pyrolysis.

115. The process as claimed in any one of claims 107 to 114;
further comprising:
removing solid material from at least the recirculating externally-disposed liquid hydrocarbon material-comprising product, such that the externally-disposed liquid hydrocarbon material-comprising product, being heated and recirculated to the reaction zone, is depleted in solids relative to the externally-disposed liquid hydrocarbon material-comprising product being discharged from the process vessel.

116. A process for producing hydrocarbon material from a hydrocarbon material precursor which includes free fatty acid material, comprising:
within an internal space of a process vessel, converting the hydrocarbon material precursor to an intermediate material mixture, wherein the converting includes reactive transformation of at least a portion of the hydrocarbon material precursor via a reactive process within a reaction zone;
in response to at least buoyancy forces, separating the intermediate material mixture into at least a gaseous hydrocarbon material-comprising product and a liquid hydrocarbon material-comprising product;
discharging the separated liquid hydrocarbon material-comprising product from the process vessel such that an externally-disposed liquid hydrocarbon material-comprising product is obtained;
removing solid material from at least a portion of the externally-disposed liquid hydrocarbon material-comprising product to obtain a solids-depleted externally-disposed liquid hydrocarbon material-comprising product; and
supplying at least a portion of the solids-depleted externally-disposed liquid hydrocarbon material-comprising product to the reaction zone.

117. The process as claimed in claim 116;
wherein:
the reactive zone is disposed at a temperature from temperature from 350 degrees Celsius to 500 degrees Celsius.

118. The process as claimed in claim 116 or 117;
wherein:
the reaction zone is disposed at a pressure from 150 psig to 250 psig.

119. The process as claimed in any one of claims 116 to 118;
wherein:
there is an absence of adscititious diatomic oxygen within the reaction zone.

120. The process as claimed in any one of claims 116 to 119;
wherein:
there is an absence of adscititious diatomic hydrogen within the reaction zone.

121. The process as claimed in any one of claims 116 to 120;
wherein:
there is an absence of decarboxylation catalyst within the reaction zone.

122. The process as claimed in any one of claims 116 to 121;
wherein:
the reactive process includes pyrolysis.

123. The process as claimed in any one of claims 116 to 122;
wherein the process is continuous.

124. A process for producing hydrocarbon material from a hydrocarbon material precursor which includes free fatty acid material, comprising:
while: (i) within an internal space of a process vessel, converting the hydrocarbon material precursor to an intermediate material mixture, wherein the converting includes reactive transformation of at least a portion of the hydrocarbon material precursor via a reactive process within a reaction zone; (ii) in response to at least buoyancy forces, separating the intermediate material mixture into at least a gaseous hydrocarbon material-comprising product and a liquid hydrocarbon material-comprising product; (iii) discharging the separated liquid hydrocarbon material-comprising product from the process vessel such that an externally-disposed liquid hydrocarbon material-comprising product is obtained; and (iv) recirculating at least a portion of the externally-disposed liquid hydrocarbon material-comprising product to the reaction zone;
removing solid material from at least the recirculating externally-disposed liquid hydrocarbon material-comprising product, such that the externally-disposed liquid hydrocarbon material-comprising product, being recirculated to the reaction zone, is depleted in solids relative to the externally-disposed liquid hydrocarbon material-comprising product being discharged from the process vessel.

125. The process as claimed in claim 124;
wherein:
the reactive zone is disposed at a temperature from temperature from 350 degrees Celsius to 500 degrees Celsius.

126. The process as claimed in claim 124 or 125;
wherein:
the reaction zone is disposed at a pressure from 150 psig to 250 psig.

127. The process as claimed in any one of claims 124 to 126;
wherein:
there is an absence of adscititious diatomic oxygen within the reaction zone.

128. The process as claimed in any one of claims 124 to 127;
wherein:
there is an absence of adscititious diatomic hydrogen within the reaction zone.

129. The process as claimed in any one of claims 124 to 128;
wherein:
there is an absence of decarboxylation catalyst within the reaction zone.

130. The process as claimed in any one of claims 124 to 129;
wherein:
the reactive process includes pyrolysis.

131. A process for producing hydrocarbon material from a hydrocarbon material precursor which includes free fatty acid material, comprising:
within an internal space of a process vessel, converting the hydrocarbon material precursor to an intermediate material mixture, wherein the converting includes reactive transformation of at least a portion of the hydrocarbon material precursor via a reactive process within a reaction zone;
in response to at least buoyancy forces, separating the intermediate material mixture into at least a gaseous hydrocarbon material-comprising product and a liquid hydrocarbon material-comprising product;
discharging the separated liquid hydrocarbon material-comprising product from the process vessel such that an externally-disposed liquid hydrocarbon material-comprising product is obtained;
based on volatility differences, fractionating at least a portion of the externally-disposed liquid hydrocarbon material-comprising product into a recovered gaseous material portion and a rejected residual slurry material portion; and
supplying the recovered gaseous material portion to the reaction zone.

132. The process as claimed in claim 131;
wherein:
the fractionating is effected within a heating zone under vacuum conditions.

133. The process as claimed in claim 131 or 132;
wherein:
the fractionating is effected within a heating zone disposed at a pressure from 0.0725 psia to 0.725 psia.

134. The process as claimed in claim 131;
wherein:
the fractionaton is effected within a heating zone; and
the heating zone is disposed at a temperature from 250 degrees Celsius to 350 degrees Celsius.

135. The process as claimed in claim 132 or 133;
wherein:
the heating zone is disposed at a temperature from 250 degrees Celsius to 350 degrees Celsius.

136. The process as claimed in any one of claims 131 to 135;
wherein:
the reactive zone is disposed at a temperature from temperature from 350 degrees Celsius to 500 degrees Celsius.

137. The process as claimed in any one of claims 131 to 136;
wherein:
the reaction zone is disposed at a pressure from 150 psig to 250 psig.

138. The process as claimed in any one of claims 131 to 137;
wherein:
there is an absence of adscititious diatomic oxygen within the reaction zone.

139. The process as claimed in any one of claims 131 to 138;
wherein:
there is an absence of adscititious diatomic hydrogen within the reaction zone.

140. The process as claimed in any one of claims 131 to 139;
wherein:
there is an absence of decarboxylation catalyst within the reaction zone.

141. The process as claimed in any one of claims 131 to 140;
wherein:
the reactive process includes pyrolysis.

142. The process as claimed in any one of claims 131 to 141;
wherein the process is continuous.

143. A process for producing hydrocarbon material from a hydrocarbon material precursor which includes free fatty acid material, comprising:
while: (i) within an internal space of a process vessel, converting the hydrocarbon material precursor to an intermediate material mixture, wherein the converting includes reactive transformation of at least a portion of the hydrocarbon material precursor via a reactive process within a reaction zone; (ii) in response to at least buoyancy forces, separating the intermediate material mixture into at least a gaseous hydrocarbon material-comprising product and a liquid hydrocarbon material-comprising product; and (iii) discharging the separated liquid hydrocarbon material-comprising product from the process vessel such that an externally-disposed liquid hydrocarbon material-comprising product is obtained;
based on volatility differences, fractionating at least a portion of the externally-disposed liquid hydrocarbon material-comprising product into a recovered gaseous material portion and a rejected residual slurry material portion; and
supplying the recovered gaseous material portion to the reaction zone.

144. The process as claimed in claim 143;
wherein:
the fractionating is effected within a heating zone under vacuum conditions.

145. The process as claimed in claim 143 or 144;
wherein:
the fractionating is effected within a heating zone disposed at a pressure from 0.0725 psia to 0.725 psia.

146. The process as claimed in claim 143;
wherein:
the fractionaton is effected within a heating zone; and
the heating zone is disposed at a temperature from 250 degrees Celsius to 350 degrees Celsius.

147. The process as claimed in claim 144 or 145;
wherein:
the heating zone is disposed at a temperature from 250 degrees Celsius to 350 degrees Celsius.

148. The process as claimed in any one of claims 143 to 147;
wherein:
the reactive zone is disposed at a temperature from temperature from 350 degrees Celsius to 500 degrees Celsius.

149. The process as claimed in any one of claims 143 to 148;
wherein:
the reaction zone is disposed at a pressure from 150 psig to 250 psig.

150. The process as claimed in any one of claims 143 to 149;
wherein:
there is an absence of adscititious diatomic oxygen within the reaction zone.

151. The process as claimed in any one of claims 143 to 150;
wherein:
there is an absence of adscititious diatomic hydrogen within the reaction zone.

152. The process as claimed in any one of claims 143 to 151;
wherein:
there is an absence of decarboxylation catalyst within the reaction zone.

153. The process as claimed in any one of claims 143 to 152;
wherein:
the reactive process includes pyrolysis.

154. The process as claimed in any one of claims 143 to 153;
wherein the process is continuous.

155. The process as claimed in any one of claims 131 to 154;
wherein:
prior to the supplying of the recovered gaseous material portion to the reaction zone, heating the recovered gaseous material portion; and
the heating of the recovered gaseous material portion includes heating in response to emplacement of the recovered gaseous material portion in heat transfer communication with the externally-disposed liquid hydrocarbon material-comprising product, such that the recovered gaseous material portion is heated by the externally-disposed liquid hydrocarbon material-comprising product.
